(19) United States
(12) Patent Application Publication
(10) Pub. No.: US 2019/0059066 A1
(43) Pub. Date: Feb. 21, 2019

(54) Time Synchronization Between Nodes Connected by a Wireless Network

(71) Applicant: Telefonaktiebolaget LM Ericsson (publ), Stockholm (SE)

(72) Inventors: János Harmatos, Budapest (HU); György Miklós, Pilisborosjenö (HU); Stefano Ruffini, Rome (IT)

(21) Appl. No.: 16/079,294

(22) PCT Filed: Feb. 23, 2016
(86) PCT No.: PCT/EP2016/053770

§ 371 Date: Aug. 23, 2018

(51) Int. Cl. H04W 56/00; H04L 12/26; H04J 3/06

(52) U.S. Cl. CPC H04W 56/0015; H04J 3/0673; H04L 43/028

(57) ABSTRACT

The inventing refers to a method of performing a synchronization communication between a master clock (100) and a slave clock (130), wherein the communication involves wireless network comprising a base station or eNB (110) and a wireless terminal or UE (120), wherein the base station (110, 110′) performs the steps of: receiving (S01) from the master clock (100) a synchronization packet (M11, M21) comprising a time information relative to the master clock (100), obtaining (S03) a first delay time accounting for an actual scheduling delay with respect to the UE (120), generating (S04) a modified synchronization packet (M12, M22) by modifying the time information to take into account the first delay time, and transmitting (S05) the modified synchronization packet (M12, M22) to the UE (120) to be forwarded to the slave clock (130). The invention further refers to a corresponding eNB (110, 110′), a method performed by the UE (120), to a corresponding UE (120) and corresponding software programs.

### TECHNICAL FIELD

The present disclosure generally relates to time synchronization within a synchronization domain comprising one or a plurality of network nodes, and more specifically relates to time synchronization involving a wireless packet data network.

### BACKGROUND

In a typical cellular system, also referred to as a wireless communications network, wireless terminals, also known as mobile stations or user equipments communicate via a Radio Access Network, RAN, to one or more core networks. The radio access network may comprise a plurality of access nodes or base stations that communicate with the wireless terminals or user equipments by means of radio signals and provide access to the core network.

The Third Generation Partnership Project, 3GPP, has established a plurality of generations of mobile communication standards. The Universal Mobile Telecommunications System, UMTS, is a third generation mobile communication system, which evolved from the Global System for Mobile Communications, GSM, to provide mobile communication services based on Wideband Code Division Multiple Access, WCDMA, access technology. Long-Term Evolution, LTE, often being referred to as fourth generation (4G), has been specified to increase the capacity and speed using orthogonal frequency division multiplexing, OFDM, in the downlink and Discrete Fourier Transform (DFT)-spread OFDM, also being referred to as single-carrier frequency-division multiple access (SC-FDMA) in the uplink.

With the ever increasing demands to increase the traffic volume and to reduce the latency, so-called fifth generation (5G) systems are currently been specified by 3GPP. Important aspects of 5G are to densify the network, and to use more spectrum. Additional available frequencies for next generation (5G) networks that are practically usable are located in very high frequency ranges (compared to the frequencies that have so far been used for wireless communication), such as 10 GHz and above.

Industry automation is also an expanding area, since tasks and complex processes are increasingly taken over by high-precision robots, automatized devices and factory cells. Many use cases require interworking of different devices and precise time synchronization of device actuation.

The required precise control in many cases can only be guaranteed if the latency between the controller unit (also being referred to as Programmable Logical Controller, PLC) and the field devices (also being referred to as IO devices or industry devices) is sufficiently low. In exemplary cases, the required end-to-end latency is in the range of 1-10 ms (e.g. for manufacturing cells), but in several extreme cases the required end-to-end latency may be less than 1 ms (e.g. for high-speed motion control).

Currently such low latency requirements of industry automation use cases are realized by wired technologies. Currently available wireless solutions, such as solutions called ISA100 wireless defined by the ISA100 Wireless Compliance Institute, WirelessHART defined by the HART Communication Foundation, or IEEE defined solution as IEEE 802.15.4 or IEEE-802.11 (also being referred to as WLAN), are not be able to provide the synchronized communication and the latency required for some use cases as described above. In the wired segment on the one hand some specific fieldbus technologies have been developed, while on the other hand industrial Ethernet-based solutions are also available. The most wide-spread and expanding Ethernet-based technology is the so-called PROFINET, which is an open, cross-vendor standard being standardized in IEC 61158, IEC 61784 for industry automation.

The PROFINET has following features and characteristics:
100% compatibility with Ethernet (according to IEEE standards),
everything on one cable: wide range of Ethernet-based communication services is supported in an integrated way, for example from data-intensive device parameter assignment, through TCP/IP-based IT communication to extremely fast data transmission between the PLC and IO devices, and
flexible and scalable real-time communication: Cycle-based communication from simple asynchronous control task to a high-precision motion control application, which requires deterministic communication for proper actions.

In case of RT (Real Time) class the latency between the controller and field device is in the 1-10 ms range and cyclic or a-cyclic communication can be used. In case of IRT (Isochronous Real Time) the delay is equal or less than 1 ms, together with 1 us jitter requirement. Most of the above mentioned industry applications may require IRT class-based communication, for others of them RT class may also be suitable.

FIG. 1 shows a typical communication cycle of PROFINET comprising different traffic classes treated within the communication cycle.

RT-3 traffic class supports the Isochronous Real-time (IRT) communication, in which devices communicate to each other in a totally synchronized way, based on a pre-defined communication plan (organized in advance by a management/planning system). In RT-3 phase each of the devices has its own allocated time slice when it can send/receive a message. Devices are not permitted to communicate outside their own time-slice, the sent data will be dropped. This synchronous communication is compliant with the strongest latency and accuracy requirement, however to achieve the required accuracy very strict synchronization requirement should be fulfilled—no more than 1 us jitter can be tolerated. Nowadays, this extreme low latency and strict synchronization accuracy can only be achieved by using wired deployment and specific (ASIC-based) hardware support.

In RT-2 traffic class, with no time-slices, the Ethernet packet are handled according to their priority (by using IEEE 802.1Q), however the start of RT-2 part of the cycle is also strictly synchronized. For loose latency use cases RT-2 enables to use unsynchronized communication, where the frame prioritization is handled, but there is no strict synchronization requirement.

In RT-1 traffic class, no synchronization is required; the frames are forwarded according to their priority stored in the VLAN header.

Unsynchronized RT-2 and RT-1 communication can be realized by using standard industrial Ethernet components and in case of longer transmission cycles even by using wireless technologies (e.g. 802.11).

Beyond low latency, a strict time synchronization of industry devices may be additionally required.

In wired, industrial Ethernet-based industry automation solution, such as PROFINET, there is a robust synchronization solution, based PTCP enables to realize automation processes that need isochronous real-time communication.

PTCP—similarly to IEEE 1588 standardized synchronization protocol, Precision Time Protocol (PTP)—uses time stamps for synchronizing devices' clocks in the network. The clocks are arranged in master-slave hierarchy. A two-way delay measurement procedure helps to calculate the delay (caused by processing time of intermediate devices, propagation delay, etc.) between a certain slave clock and the master clock. The delay measurement may be performed multiple times in order to minimize the jitter. PTP-based synchronization is able to provide about 1 us synchronization accuracy in a wired (Ethernet) industrial environment.

Differently to previous generations, the fifth generation mobile technology (5G) will be able to provide a much wider range of services compared to 4G technology. It will enable a fully connected society, which goes beyond just everything is connecting by wireless. A rich set of use cases will be supported from Mobile Broadband, machine-to-machine (M2M), Internet of Things (IoT), connected cars, homes, etc. through numerous Industrial services which needs extra low latency, extra high reliability, which cannot be handled by the current mobile system.

The expected performance of the new 5G radio interface and the new, flexible core network will be suspected to guarantee such low latency, which meets the strict requirements of the industry automation use cases. Consequently, 5G is being expected to provide a relevant wireless technology for deploying industry use case on a wireless platform. However, above-described synchronization cannot be readily applied to industry automation applying wireless communication.

### SUMMARY

It is thus an object to provide a synchronization method and means thereto that allow an employment in networks involving a wireless packet data network, though guaranteeing high synchronization accuracy.

According to embodiments, a method of synchronization communication is performed between a master clock and a slave clock, wherein the communication involves wireless network comprising a base station or eNB and a wireless terminal or UE, wherein the base station performs the following steps:
receiving from the master clock a synchronization packet comprising a time information relative to the master clock,
obtaining a first delay time accounting for an actual scheduling delay with respect to the UE,
generating a modified synchronization packet by updating the time information to take into account the first delay time, and
   transmitting the modified synchronization packet to the UE to be forwarded to the slave clock (e.g. being comprised by an industry device). In an embodiment, generating the modified synchronization packet is performed by generating a new synchronization packet or modifying the existing synchronization packet.

In an embodiment, a base station or eNB of a wireless network is disclosed being adapted for communicatively connecting a master clock to the wireless device or UE, wherein the base station may comprise:
a receiving module adapted for receiving from the master clock a synchronization packet comprising a time information relative to the master clock,
a first time delay determining module adapted for obtaining a first delay time accounting for an actual scheduling delay with respect to the UE,
a modification module adapted for generating a modified synchronization packet by modifying the time information to take into account the first delay time, and
a transmission module adapted for transmitting the modified synchronization packet to the UE to be forwarded to the slave clock.

In an embodiment, the method uses afore-mentioned Precision Transparent Clock Protocol, PTCP. The synchronization packet is then a PTCP packet that may comprise a time stamp indicative of the time of the master clock at the generation or transmission time at the master clock.

Afore-described embodiments solve the problem of unpredictable delays within the wireless network, e.g. caused by radio scheduling or radio framing that cannot be performed with a sufficient accuracy by applying the normal IEEE1588 delay measurement process.

This solution can provide synchronization to a plurality if industry devices connected to different base stations without requiring synchronization among the clocks of the base stations. The mobile system may have its own synchronization solution independent from the master clock.

In an embodiment, a method for performing a synchronization communication between master clock and slave clock is disclosed wherein the UE performs the following steps:
receiving a modified synchronization packet,
detecting, if the modified synchronization packet is to be forwarded,
in the affirmative, forwarding the modified synchronization packet to the slave clock.

In an embodiment, a corresponding UE is disclosed comprising:
a receiving module adapted for receiving a modified synchronization packet,
a detection module adapted to detect, if the synchronization packet (M12, is to be forwarded, and
a transmission module adapted to forwarding the modified synchronization packet to the slave clock, if it is to be forwarded.

Present embodiments also concern computer programs comprising portions of software codes in order to implement the method as described above when operated by a respective processing unit of appropriate nodes, e.g. a wireless terminal or a base station of a radio access network. The computer program(s) can be stored on a computer readable medium. The computer-readable medium can be a permanent or rewritable memory within the wireless terminal or base station, or located externally. The respective computer program can be also transferred for example via a cable or a wireless link as a sequence of signals.

In the following, detailed embodiments of the present invention shall be described in order to give the skilled person a full and complete understanding. However, these embodiments are illustrative and not intended to be limiting.

### BRIEF DESCRIPTION OF THE DRAWINGS

The accompanying drawings illustrate several aspects of the disclosure, and together with the description serve to explain the principles of the disclosure.

FIG. 1 illustrates a typical communication cycle of PROFINET comprising different traffic classes treated within the communication cycle as discussed in the background section;

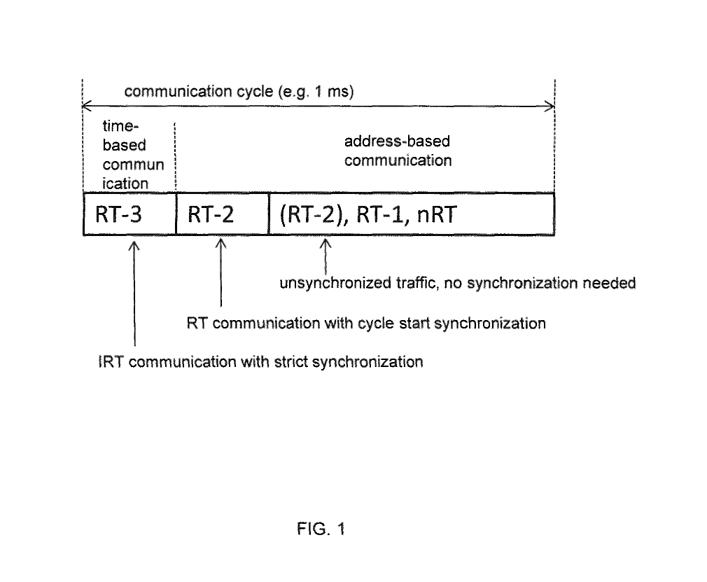

FIG. 2 shows a block diagram illustrating a synchronization (sub-) domain including a master clock, a base station, a plurality of wireless terminals and a plurality of industry or IO devices involved in a synchronization;

FIG. 3 illustrates potential delays due to scheduling in the base station;

FIG. 4 shows a block diagram comprising selected devices of FIG. 2 to perform an exemplary synchronization;

FIG. 5 illustrates exemplary delay measurement processes between the nodes depicted in FIG. 4 in order to support the synchronization;

FIG. 6a shows a first sequence diagram illustrating exemplary steps to perform a unicast synchronization between the master clock and the IO device of FIG. 4;

FIG. 6b shows timing diagram to FIG. 6a;

FIG. 7a shows a first sequence diagram illustrating exemplary steps to perform a broadcast synchronization;

FIG. 7b shows timing diagram to FIG. 7a;

FIG. 8 shows a first block diagram showing exemplary structural units of the base station according to some embodiments of the present disclosure;

FIG. 9 shows is a second block diagram showing exemplary functional units of the base station according to some embodiments of the present disclosure;

FIG. 10 shows is a third block diagram showing exemplary structural units of the wireless terminal according to some embodiments of the present disclosure; and

FIG. 11 shows a fourth block diagram showing exemplary functional units functional units of the wireless terminal according to some embodiments of the present disclosure.

### DESCRIPTION

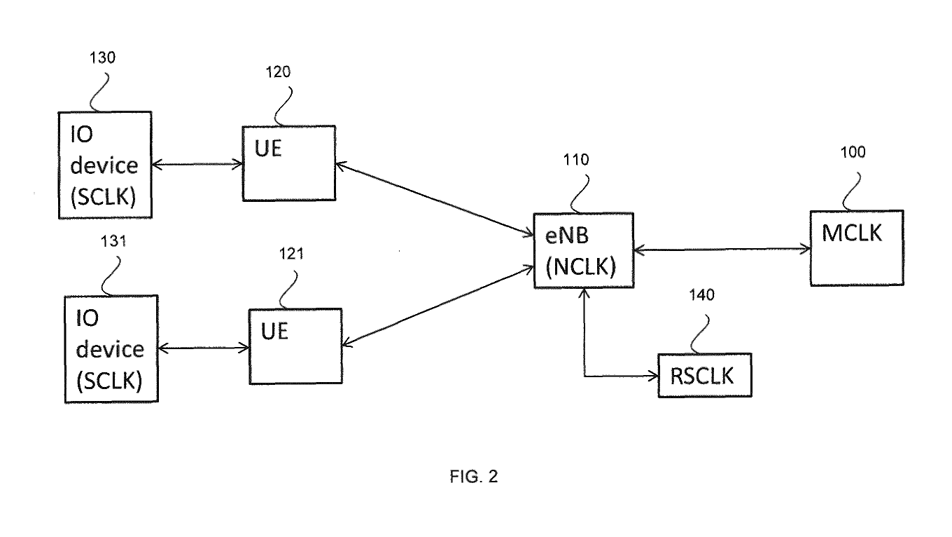

An example synchronization (sub-) domain as depicted in FIG. 2 may include a master clock (MCLK) 100, and one or more industry or IO devices 130 and 131. The IO devices 130 and 131 each comprise a slave clock (SCLK) that receives synchronization data packets from the master clock. Further, one or more instances of wireless terminals or wireless communication devices 120 and 121 e.g. user equipments (UE), machine type communication (MTC) or machine-to-machine (M2M) equipments) and a (radio) access node or base station 110, e.g. an eNB according to 3GPP 4G and especially 5G standards, capable of performing radio communication with the wireless communication devices. The base station 110 further comprises an eNB-clock (NCLK) that may be synchronized to a master clock of the radio access network (RSCLK) 140 (e.g. by using IEEE1588 PTP frames). In the following, the wireless communication devices 120 and 121 are being exemplarily referred to as UE 120 and UE 121, and the base station is being exemplarily referred to as eNB. Further, synchronization will be exemplarily explained by using afore-mentioned Precision Transparent Clock Protocol (PTCP), whereby the synchronization data packets may comprise PCTP frames sent from the master clock via the wireless network node(s) to the IO devices.

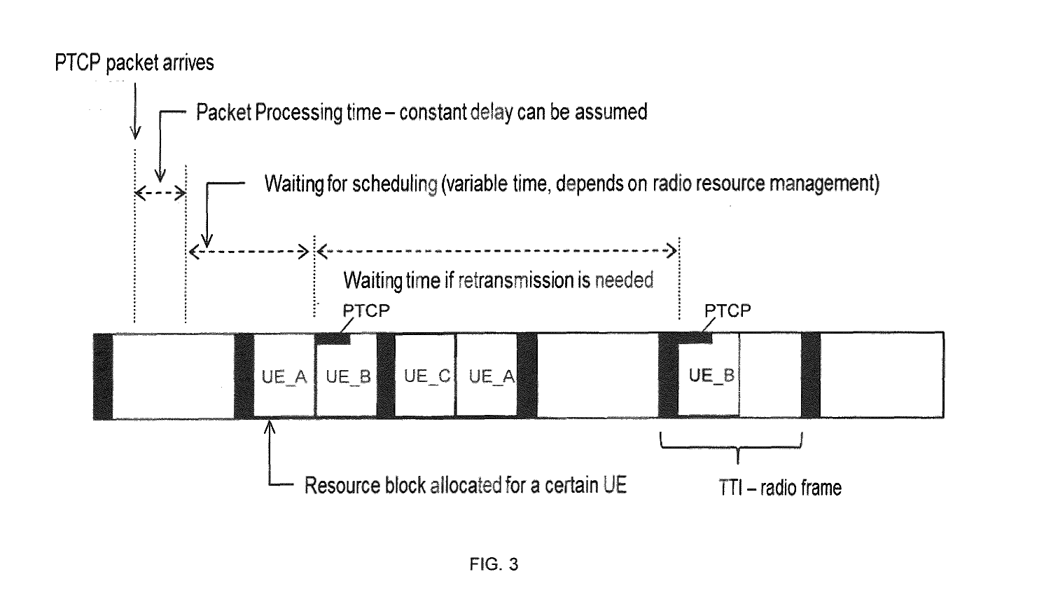

FIG. 3 illustrates potential delays between the master clock and the IO device arising from scheduling in the eNB: The arriving of PTCP packet is not synchronized to the radio frame structure, so after the packet processing time the PDU gets a variable delay until the start of the next radio frame. Furthermore, a plurality of UEs (UE_A, UE_B, and UE_C as exemplarily shown in FIG. 3) may have to be handles so that it may take an additional delay time until the destination UE (UE_B in the example of FIG. 3) is scheduled. A further significant potential delay variation factor may be a HARQ retransmission of a PDU. Thus, an overall unpredictable delay e.g. of several hundreds of microseconds (or even some milliseconds) may impact occur. By employing principles described in the following, it is possible to compensate the effects of unpredictable (and predictable) delays so to achieve a synchronization uncertainty far below the variation of unpredictable delay, e.g. in the range of or even below 1 microsecond.

Returning to FIG. 2, the eNB 110 is adapted to detecting an arrival of a synchronization data packet from the master clock 100 (e.g. by using deep packet inspection, DPI) to obtain information about when a certain UE is selected for scheduling, and obtaining information when an arriving packet (e.g. the PTCP frame) is placed in the radio frame structure (which resource element carries the PTCP PDU) to be further forwarded. The eNB determines the corresponding delay or offset time, adapts the synchronization data packet such that it is indicative of the offset time and forwards the such adapted synchronization data packet to the IO devices.

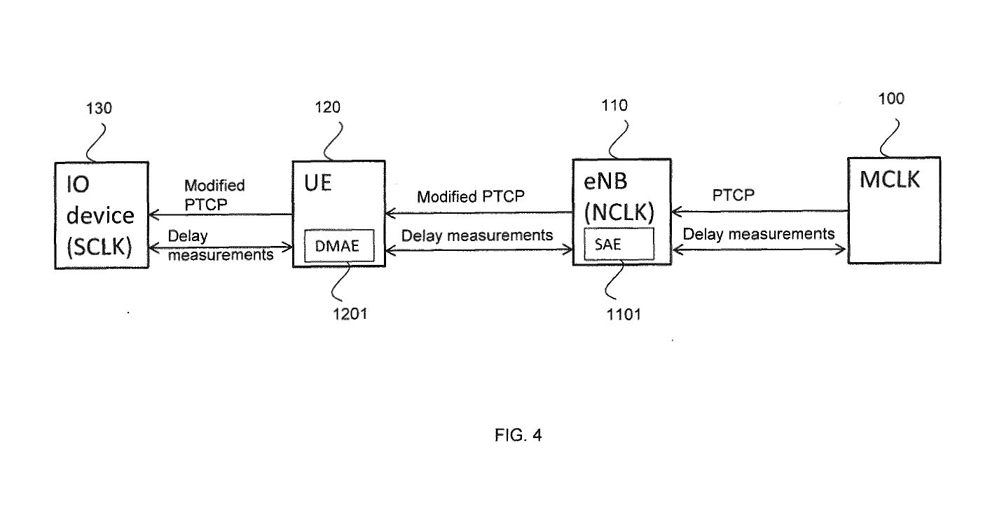

The following description shall illustrate some embodiments of a clock synchronization involving a wireless network in more detail. FIG. 4 thereto shows a block diagram comprising the master clock 100, the eNB 110, the UE 120 and the IO device 130 of FIG. 2. The master clock 100 and the IO device 130 may constitute a (part of) a synchronization subdomain of an industry network. The eNB 110 and the UE 120 are exemplary nodes of a wireless network that is involved in the synchronization communication between the master clock 100 and the IO device 130. The UE 120 may be connected to the IO device 130 by any technology, e.g. wired or by radio. Alternatively, the UE and the IO device may form an integrated device.

The master clock 100, as well as the IO device 130 may belong to a set of factory devices which applies afore-mentioned PTCP. The master clock 100 may constitute a so-called synchronization domain, which may comprise a plurality of industry devices, of which IO device 130 is shown by way of example; the industry devices (or some of them) may e.g. be connected via wired deployment (e.g. PROFINET).

In accordance to PTCP, in order to synchronize the IO device 130, the master clock 100 may transmit a PTCP frame over the eNB 110 and the UE 120 to the slave clock 130. The PCTP frame comprises information indicative of a time value (that may take into account a local delay time) of the master clock.

The eNB 110 may act as a PTCP node in the transmission link between the master clock 100 and the slave clock (IO device 130), e.g. as a so-called transparent clock. In such role, the eNB modifies the delay information such that it adds a delay that is due to internal delay or processing, and forwards such modified PCTP frame to be forwarded to the UE 120.

In order to determine the eNB internal delay time, the base station may comprise a set of synchronization functions, in the following also being referred to as synchronization assistant entity, SAE 1101. The SAE 1101 participates in the delay measurement between the master clock 100 and the slave clock of the IO device 130.

The SAE 1101 may comprise the following functions or functionality:
PTCP/PTP-awareness: detecting an arrival of a PTCP packet at the base station, e.g. by using DPI;
Scheduling awareness: obtaining information about when a certain UE is selected for scheduling, and obtaining information when an arriving packet (e.g. the PTCP frame) is placed in the radio frame structure (which resource element carries the PTCP PDU) to be further forwarded.

A further set of functions, in the following also being referred to as delay measurement assistant entity, DMAE 1201 may be implemented in the UE 120. The DMAE may cooperate with SAE 1101 to perform delay measurements between eNB 110 and UE 120. The DMAE may further be involved in delay measurements between UE 120 and IO device 130. The DMAE may provide a time offset information indicative of such delay between the UE 120 and the IO device 130, e.g. be used by the slave clock of the IO device 130. The IO device 130 may then added such delay to the other delay conveyed by the modified PTCP frame.

In unicast communications, the PTCP frame may be sent towards the IO device when a Physical Resource Block (PRB) is allocated for its serving UE. According to current LTE standards, the length of a PRB is 1 ms while in 5G radio a significantly smaller PRB is expected (e.g. several times of 10 us), and it may already perform the desired latency criteria, but not an accuracy desired for synchronization. In unicast, only a single UE communicates in a given time frame, so the IO devices which are connected to a common base station can get the synchronization information at different times (when their UEs are scheduled).

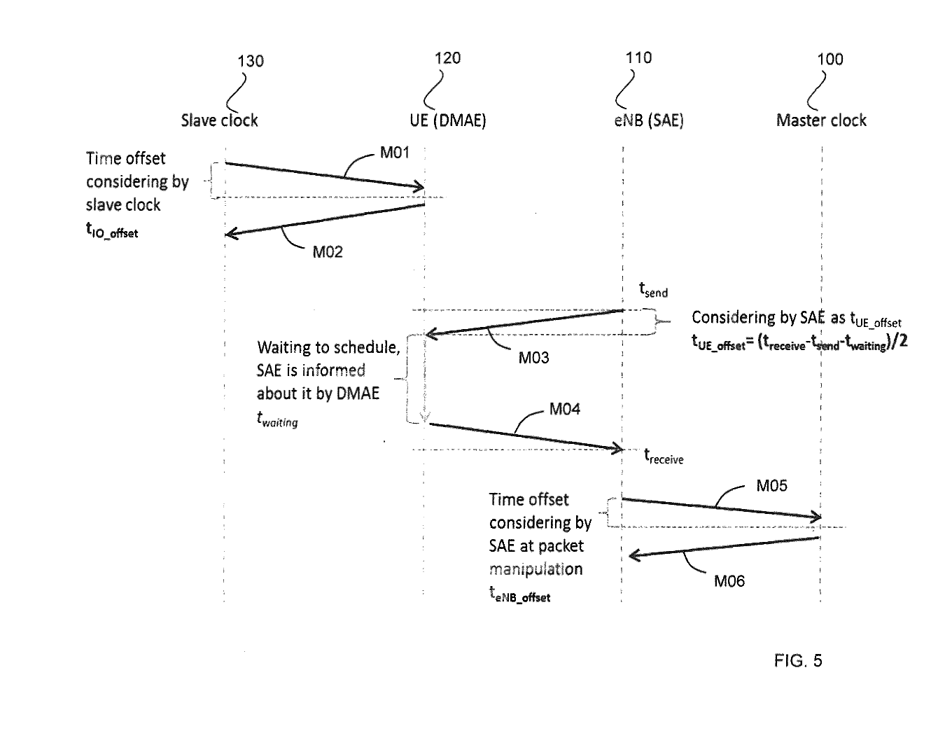

The following FIG. 5 shows an exemplary delay measurement synchronization process by means of unicast communications.

In an embodiment, a delay measurement between the UE 120 and the IO device 130 may be performed by the IO device:

When the IO device 130 initiates a delay request message M01, the DMAE 1201 detects it and responds e.g. as a (virtual) master clock (e.g. according to a peer delay measurement procedure) by delay response message M02. By using this procedure the slave clock in the IO device 130 can determine a one way delay t_{IO}_{_}_{offset} (e.g. as half the time between sending of delay request message M01 and reception of reception of response message M02). This value may be used as a time offset t_{IO}_{_}_{offset} related to the IO device 130, e.g. to be added to a timestamp carried by the incoming PTCP packet.

Alternatively, the IO device 130 may be configured to add a pre-configured constant time offset to the PTCP provided time, corresponding to the downlink delay between the reception of the downlink PDUs in the UE and the industry device. (Such pre-configuration can also be implemented by a virtual master clock in the IO device). Especially in cases, wherein this value is small or negligible (e.g. if it is in the order of a few ns in case of a distance in the order of 1 m) it may not be necessary to perform a delay measurement between the UE and the IO device.

In an embodiment, the delay measurement between the SAE 1101 and the UE may be considered to consist of two parts: a first part is the propagation delay and a second part is the processing of PTCP PDU in the UE.

To calculate the delay, the SAE 1101 may initiate a delay measurement process to send out a delay test message M03 to be received by the DMAE 1201. Since in this measurement only the SAE and DMAE communicate with each other, not standardized (or proprietary) messages may be used.

Thereto the following steps may be performed by the DMEA:
receiving the test message M03 from the SAE;
logging a sending time tₛₑₙₜ indicative the time when the test message is scheduled on the radio;
in response to the test message, preparing a test response message M04;
logging a waiting time t_{waiting} indicative of how much time is spent between the assembly of the response message PDU and the forwarding of it on the radio (as the response message has to wait in the output buffer of the UE for the scheduling);
sending the test response message M04 comprising information about this time value t_{waiting} to the SAE.

The following steps may be performed by the SAE:
receiving the test response message M04 and logging the corresponding receive time t_{receive},
calculating the one way delay between the eNB and UE e.g. as follows:

t_{UE}_{_}_{offset}=(t_{receive}−tₛₑₙₜ−t_{waiting})/2

If no synchronization support function is implemented in the UE (i.e. if no DMAE is implemented), the processing time may be approximated by a pre-configured constant as mentioned above; the propagation time between the eNB and the UE may be estimated in the eNB, e.g. by means of timing advance measurements.

In an embodiment, a delay measurement of a time delay between the eNB 110 and the master clock 100 is performed (that may be performed for each of a plurality of base stations associated to the synchronization sub domain). Thereto, a standard PTCP peer delay measurement may be performed. The eNB 110 may send a PTCP delay request message M05 towards the master clock 100. In response to the delay request message M05 the master clock 100 responds with a delay response message M06; based on this, the time delay between master clock and eNB may be determined. This delay value (t_{eNB}_{_}_{offset}) may be assumed to be as accurate as in a wired industry deployment, since local communication is assumed (limited hops between the master clock and the base station) and the PTCP packet is assigned by high priority.

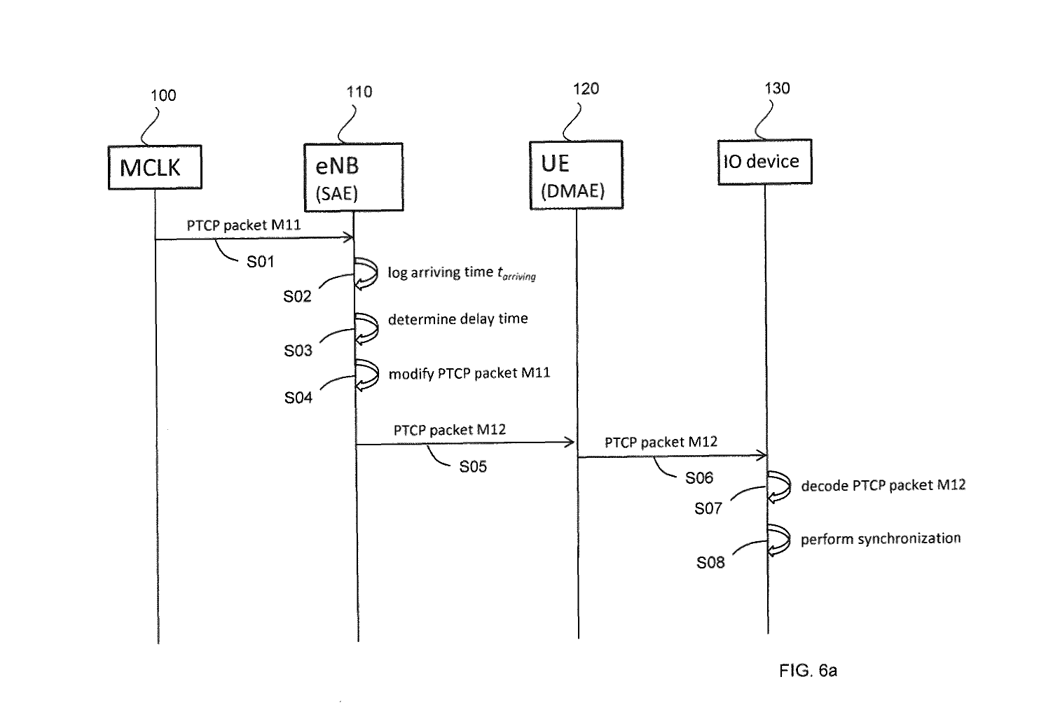

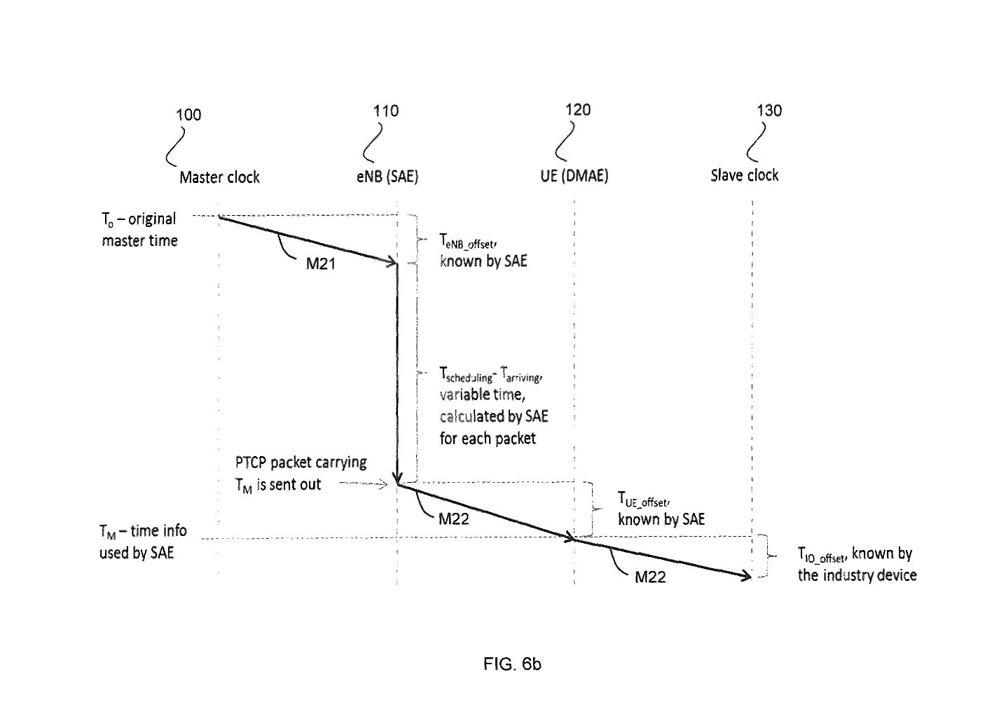

In the following FIG. 6a and FIG. 6b, an exemplary delay measurement process between master clock 100, an eNB 110, a UE 120 and an IO device 130 is depicted. By way of example, the eNB 110 comprises afore-described SAE 1101 and the UE 120 comprises afore-described DMAE 1201:

At the master clock 100:
step S01: sending a PTCP packet M11 to the eNB 110, the PTCP packet M11 comprising a time information indicative of the original master time.

At the eNB 110:
step S02: detecting the PTCP packet M11 arriving at the eNB and logging the (absolute) time of the arriving time t_{arriving} e.g. by using the slave clock of the eNB;
step S03: determining an internal (variable) delay time t_{variable}; in this example, the internal delay time is calculated as

t_{variable}=t_{scheduling}−t_{arriving},
wherein t_{scheduling} is a scheduling time that may be determined by detecting a downlink slot, in which the UE will be served;
step S04: modifying a time information of PTCP packet M11 to add the internal delay time, and
step S05 sending a such modified PTCP packet M12 to the UE 120.

At the UE 120:
step S06: receiving the modified PTCP packet M12; and forwarding the modified PTCP packet to the IO device 130.

At the IO device 130:
step S07: decoding the time delay information of the received modified PCTP packet M12, and
step S08: performing a synchronization by using the time delay information.

Additionally, a packet processing time within the eNB may be determined or assumed indicative of how much time is to be used to prepare a radio PDU from the incoming PTCP frame; the packet processing time may be added to the scheduling time (and such to the internal delay time).

Further additionally, afore-discussed offset time values t_{UE}_{_}_{offset} for the given UE and t_{eNB}_{_}_{offset} for the delay between master clock and eNB may be taken into account. In particular, the time information (or correction field) of the sync message may in conclusion be increased by the following time offset:

t_{offset}=t_{variable}+t_{eNB}_{_}_{offset}+t_{UE}_{_}_{offset}

This time offset value compensates for the delay caused by the waiting for UE scheduling and considering the eNB—master clock and eNB—UE delay; further a measured or assumed processing time in the UE may be added to the time offset.

Accordingly, the new time information carried by the modified PCTP packet M12 recovered by slave clock of the IO device 130 will be:

T_{M}=Tₒ+t_{offset},

wherein Tₒ is the original master time, i.e. the time being included in the PTCP frame by the master clock 100n and T_{M} is the corrected time corrected by the SAE to being transmitted from the eNB to the UE.

Upon reception of the modified PCTP packet M12, the UE will send the modified PTCP packet M12 to the IO device (slave clock) by forwarding the modified PCTP packet M12. The IO device may add afore-determined offset time t_{IO}_{_}_{offset} such that the accurate time information in the IO device T_{M′} can be calculated as:

T_{M′}=T_{M}+t_{IO}_{_}_{offset}

PTCP packets may use dedicated bearers with a specific QCI value; thus the eNB may make a pre-allocation of the scheduling time of the PTCP frames. (Alternatively, instead of using dedicated bearers only for PTCP packets, it is possible to identify those packets by DPI as well.) This is well feasible as the amount of such packets is rather small. The knowledge of the pre-allocated time schedule for PTCP frames facilitates for the eNB to know when the given PTCP frame will be scheduled, even before the eNB may perform segmentation and encryption of the PTCP packet.

According to embodiments, the eNB acts as a so-called transparent clock. Alternatively, the eNB may act as a so-called boundary clock. In principle, both approaches are similar in that the SAE (and the DMAE) are able to properly process the PTCP packets.

In case of the transparent clock implementation the SAE may modify the existing PTCP packet. Since PTCP is carried over UDP/IP, in this case the checksum of the UDP packet may be re-calculated according to the modified data to keep the integrity of the packet.

In case of the boundary clock approach, a corresponding functionality may be implemented as part of the SAE such that a new PTCP packet may be generated by the boundary clock with the correct time value.

Usually more than one IO devices are handled by the base station. In this case the SAE's responsibility may be to handle the synchronization of all devices. When a new PTCP packet arrives, SAE detects and catches it as described above and logs the new arrival time t_{arriving}.

In an embodiment, a hybrid automatic repeat request (HARQ) based retransmission is taken into account. This may be handled in one of the following ways:
the PDU is dropped and PTCP packet is not sent in the current scheduling period. When the UE is selected for scheduling again, another PTCP packet with valid time information is sent;
the DMAE function in the UE is extended to be able to detect a re-transmission of PTCP PDUs. If the re-transmission occurs, the DMAE drops the PTCP packet, so that it is not transmitted with the invalid time information towards the IO device.

In the following, an embodiment for a delay measurement in case of synchronization via broadcast or multicast will be considered:

The delay measurement between the IO device 130 and the UE 120, as well as the delay measurement between the eNB 110 and the master clock 100 may be similar to the unicast case examples described above.

The delay measurement between the eNB and the UEs may be performed on a per UE basis, in a way similarly as in the above-described unicast example. However, since the PTCP message is broadcasted, the individual delay t_{UE}_{_}_{offset} between the eNB and a given UE cannot be determined at the eNB. Therefore instead of the individual delay t_{UE}_{_}_{offset} the base station may us an estimated, approximated or averaged delay value of a plurality of individual delay values (t_{Aver}_{_}_{UE}_{_}_{offset}) to be used to modify the time information in the PTCP packet.

Compared to the unicast synchronization, such method may cause some inaccuracy in the synchronization, wherein the inaccuracy is proportional to the variance of the individual delay values t_{UE}_{_}_{offset} between the base station and the UE. The variance may arise from the different distances between the UEs and the base station. However this difference may be limited, since most industrial (factory) deployments are done on a geographically limited area. In such case significant differences are not expected in the UE−eNB distances for UEs that are connected to the same eNB.

Another factor, which may cause some variance, may be a processing time difference among UEs, but in industry automation, UEs having an improved performance may be applied, that keep the processing time differences below defined limits.

As discussed, if synchronization is performed via broadcast way, a synchronization inaccuracy may be higher than a synchronization inaccuracy performed via unicast; so synchronization via unicast may be preferred over synchronization via broadcast in use cases that require very strict synchronization accuracy (e.g. 1 us).

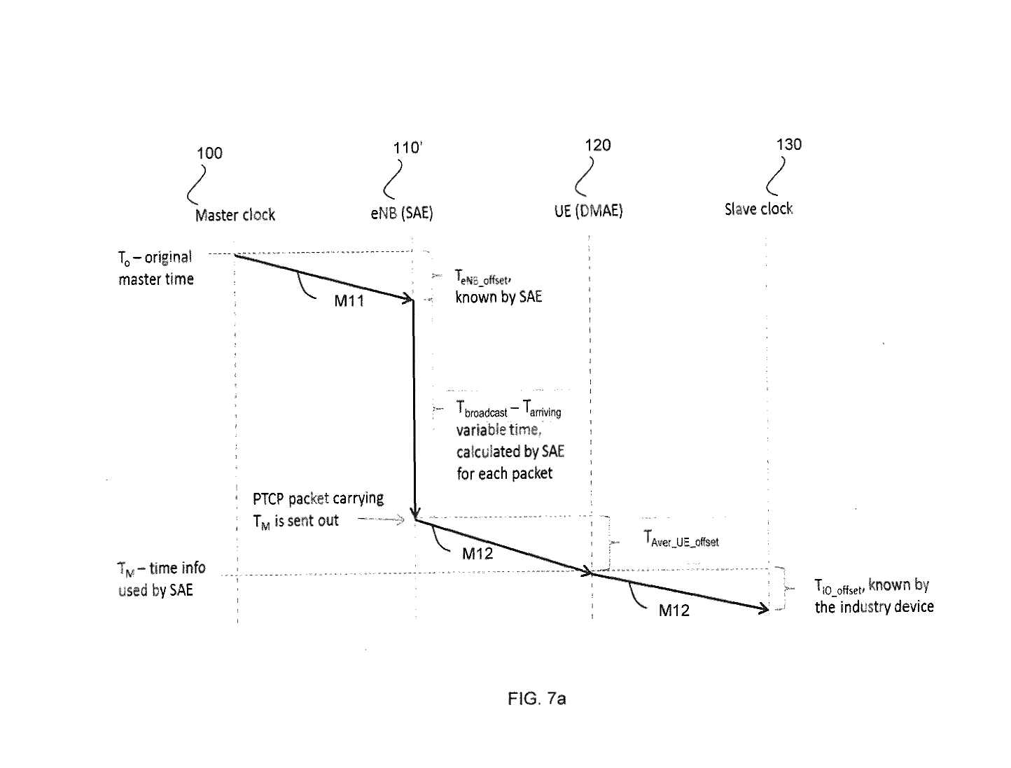

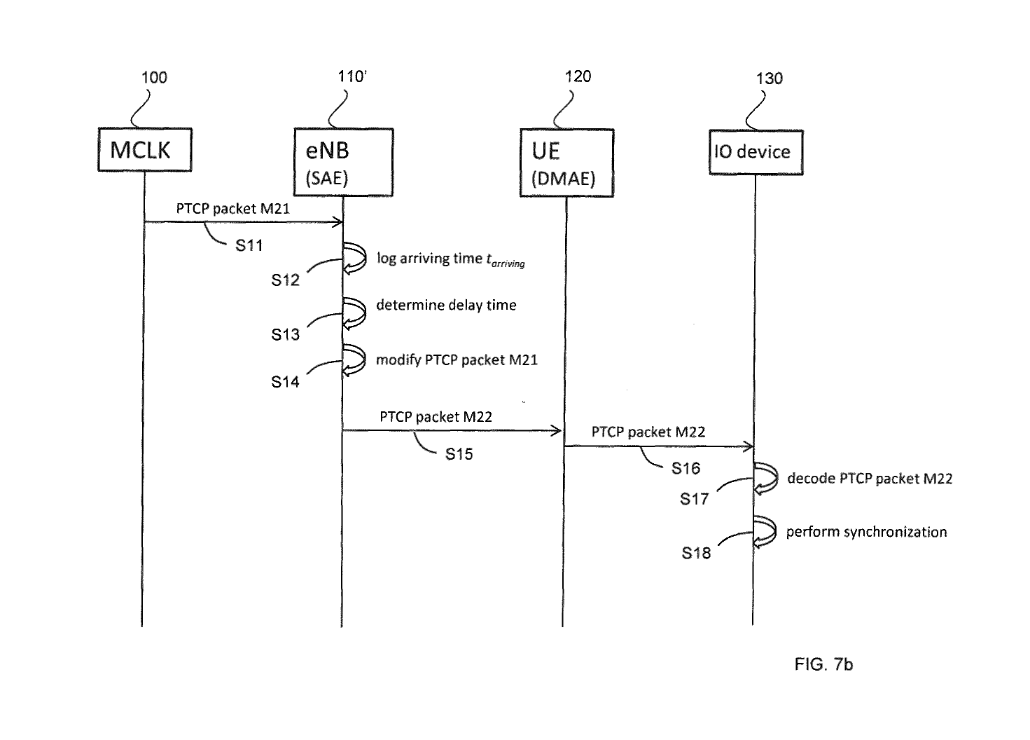

In the following FIG. 7a and FIG. 7b, an exemplary delay measurement process by means of broadcasting is shown. FIG. 7a and FIG. 7b show essentially the same nodes or devices as FIG. 6a and FIG. 6b respectively, namely master clock 100 UE 120 and IO device 130. Instead of eNB 110, a modified eNB 110′ is depicted as being involved in the communication. Modified eNB 110′ differs from the eNB 110 in that it comprises a modified SAE operable for synchronization by means of broadcasting/multicasting. In the following description, mainly broadcasting synchronization mode is discussed, but the described functions would be essentially similar for multicast.

A modified eNB operable for synchronization by means of broadcasting may have the following functions:
detecting an arrival time of a PTCP arriving at the base station; the clock of the base station may be used to log the (absolute) arrival time t_{arriving} of the PTCP packet;
determining a start time of the broadcast period in the next radio frame t_{broadcast} (since the SAE is aware on radio frame structure, it knows when the broadcast period in the next radio frame starts).

If there is time to process the PTCP packet before the next broadcast period, the SAE may modify the time information of the PTCP packet, or may generate a new PTCP packet (similar to above-described unicast case embodiment);

otherwise the next broadcast period may be used to transmit the synchronization information towards the UEs.

In the example of FIG. 7a and FIG. 7b the following steps are performed:

At the master clock 100:
step 11: broadcasting a PTCP packet M21 from the master clock 100 towards the eNB 110′.

At the eNB 110′:
step 12: detecting an arrival of the broadcasted PTCP packet M21 and logging the (absolute) time of the arriving of PTCP packet (t_{arriving}) e.g. by using the slave clock of the eNB;
step 13: determining the internal delay time t_{variable}; in this example, the delay time is
t_{variable}=t_{broadcast}−t_{arriving}, wherein t_{broadcast} is a start time of the broadcast period in the next radio frame,
step 14: modifying a time information of the detected PTCP packet M21 to add the internal delay time, and
step 15: sending a such modified PTCP packet M22 to the UE 120.

At the UE 120:
step 16: receiving the modified PTCP packet M22; and forwarding this packet to the IO device 130.

At the IO device 130:
step 17: decoding the time delay information of the received modified

PCTP packet M22, and
step 18: performing a synchronization by using the time delay information.

The modified SAE may further comprise function to perform the following measurements:
performing a delay measurement between itself and the master clock of the industry system, in order to obtain a first offset time values t_{eNB}_{_}_{offset};
performing delay measurements between itself and a plurality of the UEs connected to the base station in order to obtain a plurality of offset time values, and determining an average of the offset time t_{Aver}_{_}_{UE}_{_}_{offset}.

The modified SAE thus may perform a time information correction in the PTCP packet to add t_{offset} according to the following calculation:

t_{offset}=t_{broadcast}−t_{arriving}+t_{eNB}_{_}_{offset}+t_{Aver}_{_}_{UE}_{_}_{offset}.

In a case where a next broadcast period is coming and no new PTCP packet has arrived at the base station, one of the two following options may be performed:
no sending of synchronization information in this period; and
modifying or re-generating a PTCP packet to be sent out.

It is to be noted that in case of broadcasting, there is no retransmission; thus the above-mentioned HARQ problem does not need to be handled.

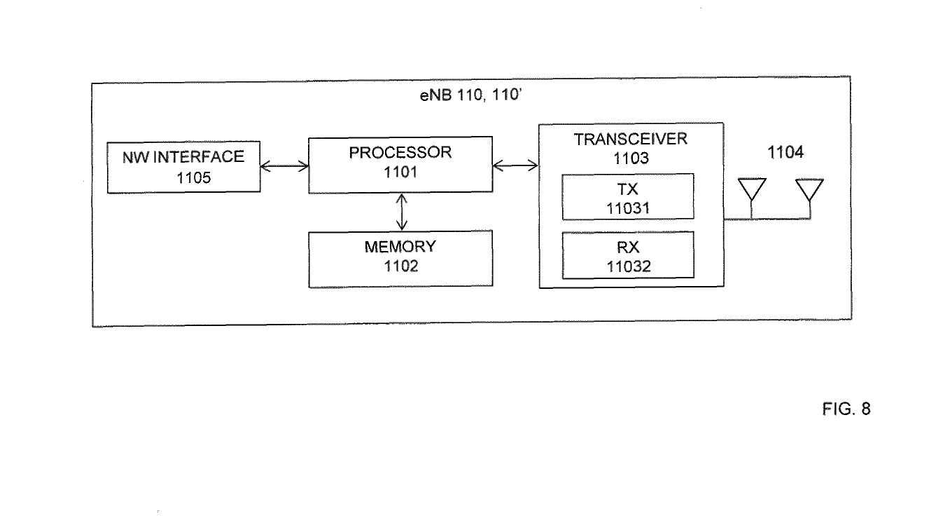

As shown in FIG. 8, the base station or eNB 110 or 110′ includes a node processor 1101, a node memory 1102, a node transceiver 1103, one or a plurality of node antennas 1104, and a network interface 1105. The node processor 1101 is coupled to the node memory 1102, to the network interface 1105, and to the node transceiver 1103. The node transceiver 1103 is further coupled to the one or the plurality of node antennas 1104. The node transceiver 1103 comprises a transmission circuit TX 11031 and a receiver circuit RX 11032. In particular embodiments, some (or all) of the functionality described above as being provided by eNB may be provided by the node processor 1101 executing respective instructions stored on a computer-readable medium, such as the node memory 1102. Alternative embodiments of the eNB may include additional components responsible for providing additional functionality, including any of the functionality identified above and/or any functionality necessary to support the solution described above.

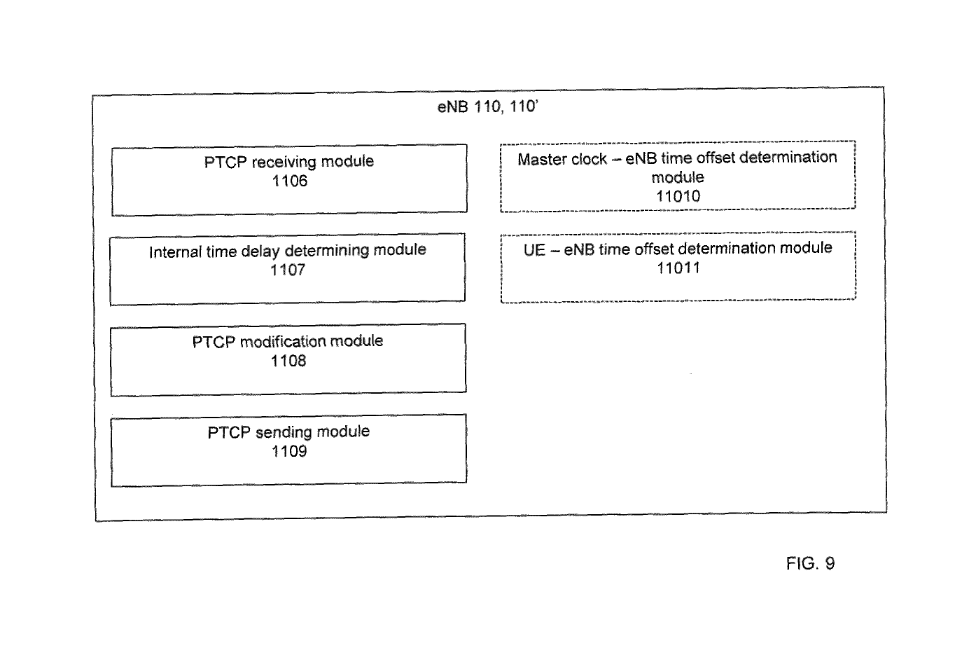

As shown in FIG. 9, an example base station or eNB 110 or 110′ includes the following exemplary functional units:
a PTCP receiving module 1106 adapted for detecting a PTCP packet M11 arriving at the eNB and logging the time of the arriving time e.g. by using the slave clock of the eNB;
a time information determining module 1107 adapted determining an internal delay time accounting for a difference between the arriving time and the sending time at the eNB;
a PTCP modification module 1108 adapted for modifying a time information of PTCP packet M11 to add the internal delay time; and
a PTCP sending module 1109 adapted for forwarding a such modified PTCP packet M12 to one or a plurality of UEs 120.

Further, the example base station or eNB 110, 110′ may comprise:
a master clock—eNB time offset determination module 11010 adapted for determining the offset t_{eNB}_{_}_{offset} as discussed above.

Further, the example base station or eNB 110, 110′ may comprise:
a UE−eNB time offset determination module 11011 adapted for determining either an individual offset delay t_{UE}_{_}_{offset} e.g. in case of unicast communication, or an average offset delay t_{Aver}_{_}_{UE}_{_}_{offset}. E.g. in case of multicast or broadcast communication.

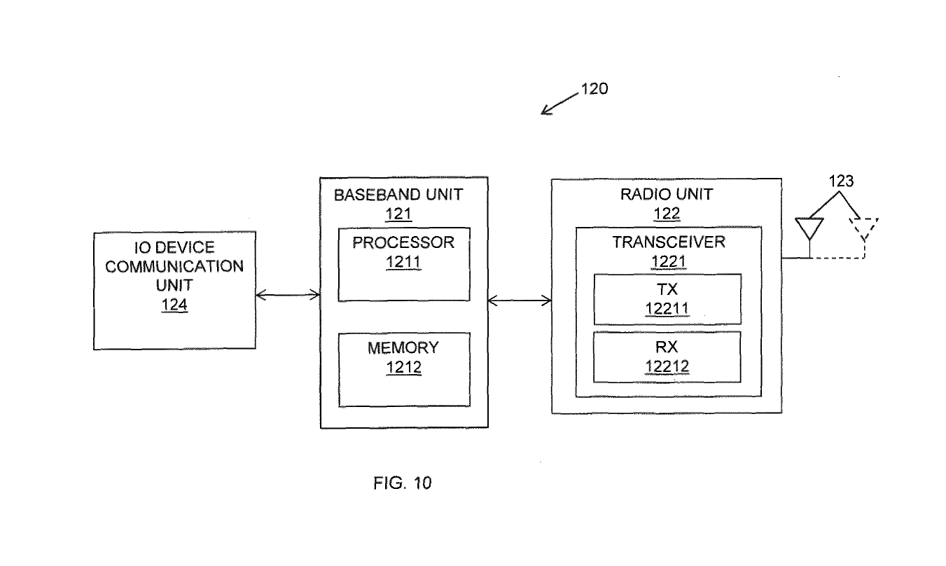

As shown in FIG. 10, an example wireless terminal or UE 120 includes a baseband unit 121, a radio unit 122 and one or a plurality of antennas 123 and a IO communication unit 124. The baseband unit 121 is coupled to the radio unit 122. The baseband unit 121 comprises a device processor 1211 and a device memory 1212. The radio unit 122 comprises a transceiver 1221 that is coupled to the one or a plurality of antennas 123. The transceiver comprises a transmission circuit TX 12211 and a receiver circuit RX 12212. In particular embodiments, some or all of the functionality described above as being provided by above-described UEs, MTC or M2M devices, and/or any other types of wireless communication devices may be provided by the device processor 1211 executing instructions stored on a computer-readable medium, such as the device memory 1211. Alternative embodiments of the wireless communication device may include additional components beyond those shown here that may be responsible for providing certain aspects of the device's functionality, including any of the functionality described above and/or any functionality necessary to support the solution described above.

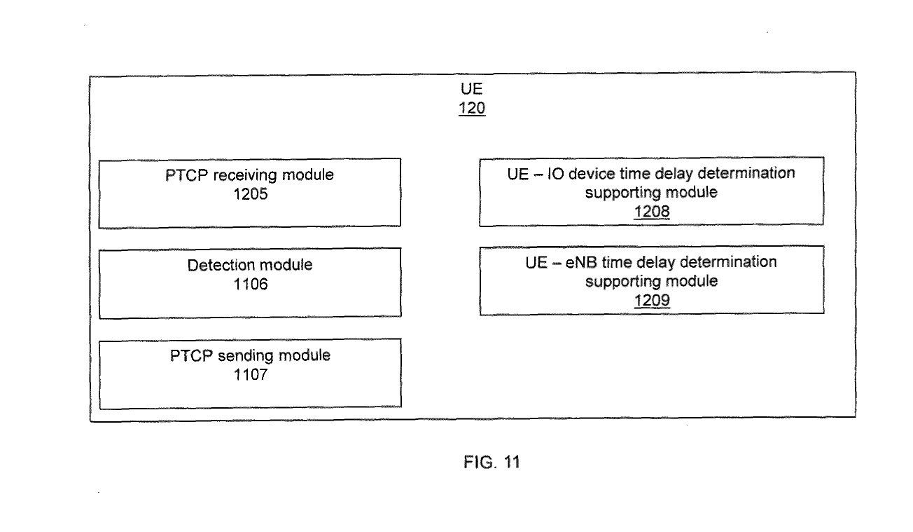

As shown in FIG. 11, the example wireless terminal or UE 120 includes the following exemplary functional units:
a receiving module 1205 adapted for receiving a modified synchronization packet M12, M22,
a detection module 1106 adapted to detect, if the synchronization packet

(M12, M22) is to be forwarded, and
a transmission module 1107 adapted to forwarding the modified synchronization packet M12, M22 to the slave clock 130, if it is to be forwarded.

The detection module 1106 may be adapted to detect if the synchronization packet M12, M22 is associated to a re-transmission, and in the affirmative, to initiate dropping the synchronization packet M12, M22 so that it is not forwarded to the slave clock 130.

The UE 120 may further comprise:
a UE-IO device time delay determination module 1208, and
A UE-eNB time delay determination supporting module 1209.

1-30. (canceled)

31. A method of performing a synchronization communication between a master clock and a slave clock, wherein the communication involves a wireless network comprising a base station and a wireless terminal, the method comprising the base station:
receiving from the master clock a synchronization packet comprising a time information relative to the master clock;
obtaining a first delay time accounting for an actual scheduling delay with respect to the wireless terminal;
generating a modified synchronization packet by updating the time information to take into account the first delay time; and
transmitting the modified synchronization packet to the wireless terminal to be forwarded to the slave clock.

32. The method of claim 31, wherein obtaining the first delay time comprises:
logging an arrival time of the synchronization packet;
determining a scheduling time at which the modified synchronization packet is scheduled to be transmitted to the wireless terminal; and
determining the first delay time as a function of the scheduled time and the arrival time.

33. The method of claim 31, wherein transmitting the modified synchronization packet to the wireless terminal comprises transmitting the modified synchronization packet using unicast communication.

34. The method of claim 31, wherein transmitting the modified synchronization packet to the wireless terminal comprises transmitting the modified synchronization packet using broadcast or multicast communication.

35. The method of claim 34, wherein receiving the synchronization packet comprises detecting the synchronization packet using a deep packet inspection in order to identify the synchronization packet amongst other data packets.

36. The method of claim 32, wherein determining the scheduling time comprises obtaining information from a radio resource management of the base station.

37. The method of claim 31, wherein the first delay time further accounts for a processing delay within the base station.

38. The method of claim 31, further comprising obtaining a second delay time accounting for a transmission delay between the master clock and the base station, wherein generating the modified synchronization packet comprises modifying the time information to take into account the first delay time and the second delay time.

39. The method of claim 31, further comprising obtaining a third delay time accounting for a transmission delay between the base station and the wireless terminal, wherein generating the modified synchronization packet comprises modifying the time information to take into account the first delay time and the third delay time.

40. The method of claim 31, wherein the time information of the synchronization packet comprises a time stamp indicative of an actual time of the master clock at the time of generation of the synchronization packet.

41. The method of the claim 40, wherein updating the time information comprises adding the first delay time to the time stamp.

42. The method of claim 31, further comprising dropping the synchronization packet from a current scheduling if the base station determines that the synchronization packet is associated with a retransmission process.

43. A method for performing a synchronization communication between a master clock and a slave clock, wherein the communication involves a wireless network comprising a base station and a wireless terminal, the method comprising the wireless terminal:
receiving a modified synchronization packet;
determining if the modified synchronization packet is to be forwarded; and
forwarding the modified synchronization packet to the slave clock if the wireless terminal determines the modified synchronization packet is to be forwarded.

44. The method of claim 43, wherein detecting if the modified synchronization packet is to be forwarded comprises:
determining if the synchronization packet is associated with a re-transmission; and
dropping the synchronization packet so that it is not forwarded to the slave clock if the wireless terminal determines the synchronization packet is associated with the re-transmission.

45. A wireless terminal adapted to be connected to base station of a wireless network, the wireless terminal comprising:
a slave clock or an interface connectable to the slave clock;
a receiver circuit adapted to receive a modified synchronization packet;
a detection circuit adapted to determine if the synchronization packet is to be forwarded; and
a transmission circuit adapted to forward the modified synchronization packet to the slave clock if the detection circuit determines the synchronization packet is to be forwarded.

46. The wireless terminal of claim 45, wherein the detection circuit is adapted to determine if the synchronization packet is to be forwarded by:
determining if the synchronization packet is associated with a re-transmission; and
initiating dropping the synchronization packet so that it is not forwarded to the slave clock if it is determined the synchronization packet is associated with the re-transmission.

47. A base station of a wireless network adapted for communicatively connecting a master clock to a wireless terminal comprising or connecting to a slave clock, the base station comprising:
a receiver circuit adapted to receive from the master clock a synchronization packet comprising a time information relative to the master clock;
a first time delay determining circuit adapted to obtain a first delay time accounting for an actual scheduling delay with respect to the wireless terminal;
a modification circuit adapted to generate a modified synchronization packet by modifying the time information to take into account the first delay time; and
a transmission circuit adapted to transmit the modified synchronization packet to the wireless terminal to be forwarded to the slave clock.

48. The base station of claim 47, wherein the first time delay determining circuit is adapted to obtain the first delay time by:
logging an arrival time of the synchronization packet;
determining a scheduling time at which the modified synchronization packet is scheduled to be transmitted to the wireless terminal; and
determining the first delay time as a function of the scheduled time and the arrival time.

49. The base station of claim 48, wherein the receiver circuit is adapted to receive the synchronization packet by detecting an arrival of the synchronization packet using a deep packet inspection in order to identify the synchronization packet amongst other data packets.

50. The base station of claim 48, wherein the first time delay determining circuit is adapted to determine the scheduling time by obtaining information from a radio resource management module of the base station.

51. The base station of claim 50, wherein the first time delay determining circuit is further adapted to account for a processing delay within the base station.

52. The base station of claim 47, further comprising a second time delay determining circuit adapted to determine a second delay time accounting for a transmission delay between the master clock and the base station, wherein the modification circuit is adapted to modify the time information to take into account the first delay time and the second delay time to generate the modified synchronization packet.

53. The base station of claim 47, further comprising a third time delay determining circuit adapted to determine a third delay time accounting for a transmission delay between the base station and the wireless terminal, and wherein the modification circuit is adapted to modify the time information to take into account the first delay time and the third delay time to generate the modified synchronization packet.

54. The base station of claim 47, wherein the modification circuit is adapted to:
detect a time stamp indicative of an actual time of the master clock at the time of generation of the synchronization packet; and
modify the time stamp in response a determined communication time delay.

55. The base station of claim 54, wherein the modification circuit is adapted to update the time information by adding the determined communication time delay to the time stamp.

56. A base station of a wireless network adapted to communicatively connect a master clock to a wireless device, the wireless device further comprising or connecting to a slave clock, the base station adapted to:
receive from the master clock a synchronization packet comprising a time information relative to the master clock;
obtain a first delay time accounting for an actual scheduling delay with respect to the wireless terminal;
generate a modified synchronization packet by updating the time information to take into account the first delay time; and
transmit the modified synchronization packet to the wireless terminal to be forwarded to the slave clock.

57. A non-transitory computer readable medium storing a computer program product for controlling a base station, the computer program product comprising software instructions which, when executed by a processor in the base station causes the base station to:
receive from the master clock a synchronization packet comprising a time information relative to the master clock;
obtain a first delay time accounting for an actual scheduling delay with respect to the wireless terminal;
generate a modified synchronization packet by updating the time information to take into account the first delay time; and
transmit the modified synchronization packet to the wireless terminal to be forwarded to the slave clock.

58. A non-transitory computer readable medium storing a computer program product for controlling a wireless terminal, the computer program product comprising software instructions which, when executed by a processor in the wireless terminal causes the wireless terminal to:
receive a modified synchronization packet;
determine if the modified synchronization packet is to be forwarded; and
forward the modified synchronization packet to the slave clock if the wireless terminal determines the modified synchronization packet is to be forwarded.
